(19) United States
(12) Patent Application Publication
(10) Pub. No.: US 2024/0079679 A1
(43) Pub. Date: Mar. 7, 2024

(54) MULTI-FUNCTIONAL CROSS-MEMBER ASSEMBLES FOR TRACTION BATTERY PACKS

(71) Applicant: FORD GLOBAL TECHNOLOGIES, LLC, Dearborn, MI (US)

(72) Inventors: Brock DUNLAP, Dearborn, MI (US); Deanna Marie Winton HOFFMAN, Ann Arbor, MI (US); Alex REVELS, Canton, MI (US)

(21) Appl. No.: 18/306,405

(22) Filed: Apr. 25, 2023

Related U.S. Application Data
(60) Provisional application No. 63/403,445, filed on Sep. 2, 2022.

(51) Int. Cl. H01M 10/6568; B60L 50/64; H01M 10/613; H01M 10/625

(52) U.S. Cl. CPC H01M 10/6568; B60L 50/64; H01M 10/613; H01M 10/625; H01M 2220/20

(57) ABSTRACT

Multi-functional cross-member assemblies are provided for traction battery packs. An exemplary cross-member assembly may function as both a structural member for supporting one or more cell stacks and further as a “cold plate” for thermally managing the one or more cell stacks. In some implementations, the cross-member assembly may include structural beam members (e.g., pultrusions) and a heat exchanger portion that includes an internal coolant circuit.

### CROSS-REFERENCE TO RELATED APPLICATIONS

This disclosure claims priority to U.S. Provisional Application No. 63/403,445, which was filed on Sep. 2, 2022 and is incorporated herein by reference.

### TECHNICAL FIELD

This disclosure relates generally to traction battery packs, and more particularly to multi-functional cross-member assemblies configured for both supporting and thermally managing subcomponents of one or more cell stacks of a traction battery pack.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A traction battery pack according to an exemplary aspect of the present disclosure includes, among other things, a first cross-member assembly, and a first cell stack supported by the first cross-member assembly. The first cross-member assembly includes an internal coolant circuit configured to thermally manage a plurality of battery cells of the first cell stack.

In a further non-limiting embodiment of the foregoing traction battery pack, the first cross-member assembly separates the first cell stack from a second cell stack of the traction battery pack.

In a further non-limiting embodiment of either of the foregoing traction battery packs, the internal coolant circuit includes a plurality of cooling channels arranged to establish a serpentine path.

In a further non-limiting embodiment of any of the foregoing traction battery packs, the first cross-member assembly includes an upper structural beam member, a lower structural beam member, and a heat exchanger portion extending between the upper structural beam member and the lower structural beam member.

In a further non-limiting embodiment of any of the foregoing traction battery packs, each of the upper structural beam member and the lower structural beam member includes a T-shaped cross-section.

In a further non-limiting embodiment of any of the foregoing traction battery packs, the upper structural beam member establishes a first pultrusion of the first cross-member assembly, and the lower structural beam member establishes a second pultrusion of the first cross-member assembly.

In a further non-limiting embodiment of any of the foregoing traction battery packs, the upper structural beam member includes an upper plateau that interfaces with an upper enclosure structure, and the lower structural beam member includes a lower base that interfaces with a lower enclosure structure.

In a further non-limiting embodiment of any of the foregoing traction battery packs, the heat exchanger portion is configured as a mixed material laminate.

In a further non-limiting embodiment of any of the foregoing traction battery packs, the heat exchanger portion includes the internal coolant circuit.

In a further non-limiting embodiment of any of the foregoing traction battery packs, a thermal interface material is disposed between the first cell stack and the first cross-member assembly.

A traction battery pack according to another exemplary aspect of the present disclosure includes, among other things, a first cell stack, a second cell stack, and a first cross-member assembly arranged between the first cell stack and the second cell stack. The first cross-member assembly includes an internal coolant circuit configured to thermally manage a plurality of battery cells of the first cell stack and the second cell stack.

In a further non-limited embodiment of the foregoing traction battery pack, a second cross-member assembly is positioned on an opposite side of the second cell stack from the first cross-member assembly.

In a further non-limiting embodiment of either of the foregoing traction battery packs, a coolant hose fluidly connects the internal coolant circuit of the first cross-member assembly to a second internal coolant circuit of the second cross-member assembly.

In a further non-limiting embodiment of any of the foregoing traction battery packs, the internal coolant circuit includes a plurality of cooling channels arranged to establish a serpentine path.

In a further non-limiting embodiment of any of the foregoing traction battery packs, the first cross-member assembly includes an upper structural beam member, a lower structural beam member, and a heat exchanger portion extending between the upper structural beam member and the lower structural beam member.

In a further non-limiting embodiment of any of the foregoing traction battery packs, each of the upper structural beam member and the lower structural beam member includes a T-shaped cross-section.

In a further non-limiting embodiment of any of the foregoing traction battery packs, the upper structural beam member establishes a first pultrusion of the first cross-member assembly, and the lower structural beam member establishes a second pultrusion of the first cross-member assembly.

In a further non-limiting embodiment of any of the foregoing traction battery packs, the upper structural beam member includes an upper plateau that interfaces with an upper enclosure structure, and the lower structural beam member includes a lower base that interfaces with a lower enclosure structure.

In a further non-limiting embodiment of any of the foregoing traction battery packs, the heat exchanger portion is configured as a mixed material laminate.

In a further non-limiting embodiment of any of the foregoing traction battery packs, the heat exchanger portion includes the internal coolant circuit.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is an exploded perspective view of a traction battery pack for an electrified vehicle.

FIG. 3 is a cross-sectional view through section 3-3 of FIG. 2 and illustrates a cross-member assembly positioned between adjacent cell stacks of a traction battery pack.

FIG. 4 illustrates another exemplary cross-member assembly for a traction battery pack.

FIG. 5 illustrates an internal coolant circuit of the cross-member assembly of FIG. 4.

FIG. 6 illustrates exemplary fluid connections between adjacent cross-member assemblies of a traction battery pack.

### DETAILED DESCRIPTION

This disclosure details cross-member assemblies for traction battery packs. An exemplary cross-member assembly may function as both a structural member for supporting one or more cell stacks and further as a “cold plate” for thermally managing the one or more cell stacks. In some implementations, the cross-member assembly may include structural beam members (e.g., pultrusions) and a heat exchanger portion that includes an internal coolant circuit. These and other features are discussed in greater detail in the following paragraphs of this detailed description.

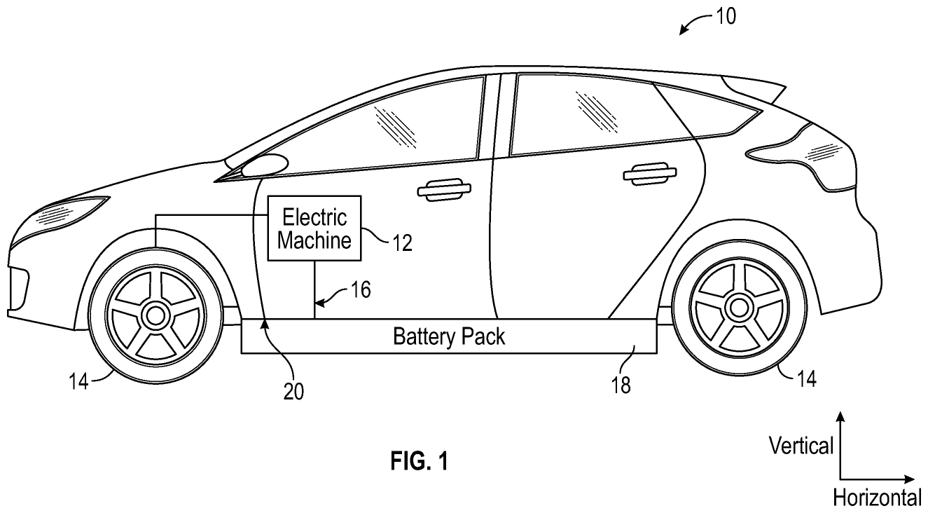

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

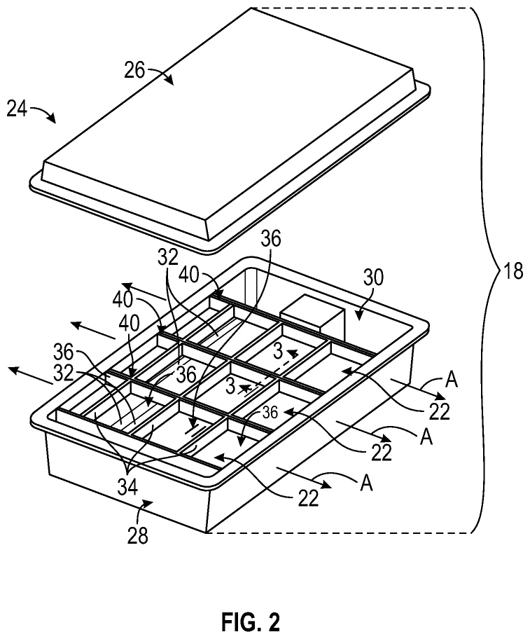

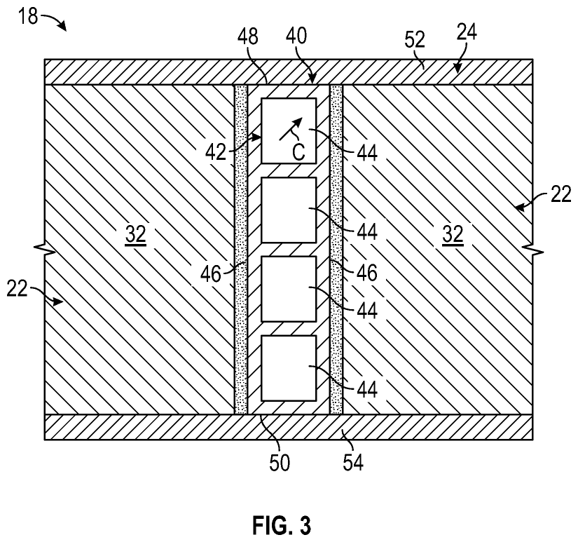

FIGS. 2 and 3 illustrate additional details associated with the traction battery pack 18 of the electrified vehicle 10. The traction battery pack 18 may include a plurality of cell stacks 22 housed within an interior area 30 of an enclosure assembly 24. The enclosure assembly 24 of the traction battery pack 18 may include an enclosure cover 26 and an enclosure tray 28. The enclosure cover 26 may be secured (e.g., bolted, welded, adhered, etc.) to the enclosure tray 28 to provide the interior area 30 for housing the cell stacks 22 and other battery internal components of the traction battery pack 18.

Each cell stack 22 may include a plurality of battery cells 32. The battery cells 32 of each cell stack 22 may be stacked side-by-side relative to one another along a cell stack axis A. The battery cells 32 store and supply electrical power for powering various components of the electrified vehicle 10. Although a specific number of cell stacks 22 and battery cells 32 are illustrated in the various figures of this disclosure, the traction battery pack 18 could include any number of the cell stacks 22, with each cell stack 22 having any number of individual battery cells 32.

In an embodiment, the battery cells 32 are lithium-ion pouch cells. However, battery cells having other geometries (cylindrical, prismatic, etc.) and/or chemistries (nickel-metal hydride, lead-acid, etc.) could alternatively be utilized within the scope of this disclosure.

One or more dividers 34 may be arranged along the respective cell stack axis A of each cell stack 22. In an embodiment, the dividers 34 establish thermal barriers along the cell stack 22. The dividers 34 may compartmentalize each cell stack 22 into two or more groupings or compartments 36 of battery cells 32. Each compartment 36 may hold one or more of the battery cells 32 within one of the cell stacks 22. In an embodiment, the battery cells 32 of each cell stack 22 are held within one of four compartments 36. However, other configurations, including configurations that utilize a greater or fewer number of compartments 36, could be used within the scope of this disclosure.

The battery cells 32 of each cell stack 22 may be arranged between a pair of cross-member assemblies 40. The cross-member assemblies 40 may serve numerous functions. For example, the each cross-member assembly 40 may be a structural beam that is configured to support the battery cells 32 of at least one cell stack 22 and at least partially delineate adjacent cell stacks 22 from one another. The cross-member assemblies 40 may be further configured to transfer a load applied to a side of the electrified vehicle 10, for example, and can help accommodate tension loads from battery cell 32 expansion and compression loads. The cross-member assemblies 40 are therefore configured to increase the structural integrity of the traction battery pack 18.

Referring now primarily to FIG. 3, the cross-member assemblies 40 may be further configured to thermally manage the battery cells 32 of the cell stacks 22 of the traction battery pack 18. For example, heat may be generated and released by the battery cells 32 of each cell stack 22 during charging operations, discharging operations, extreme ambient conditions, etc. It may be desirable to actively remove the heat from the cell stacks 22 to enhance the capacity and life of the battery cells 32. Each cross-member assembly 40 may thus be configured as a heat exchanger or “cold plate” for conducting the heat out of the battery cells 32. In other words, the cross-member assemblies 40 may function as heat syncs to remove heat from the heat sources (i.e., the battery cells 32). In some implementations, the cross-member assemblies 40 can alternatively be employed to heat the battery cells 32 of the cell stacks 22, such as during relatively cold ambient conditions.

In an embodiment, an internal coolant circuit 42 may be provided within each cross-member assembly 40 for performing the heat transfer functions described in the preceding paragraph. A coolant C may be selectively circulated through the internal coolant circuit 42 to thermally condition the battery cells 32 of one or more of the cell stacks 22. In the illustrated embodiment, the cross-member assembly 40 is arranged to thermally condition the battery cells 32 of two cell stacks 22.

In an embodiment, the coolant C is a conventional type of coolant mixture such as water mixed with ethylene glycol. However, other coolants, including gases, are also contemplated within the scope of this disclosure.

In an embodiment, the internal coolant circuit 42 includes a plurality of cooling channels 44 that extend inside the cross-member assembly 40. The cooling channels 44 may be fluidly connected to one another. In an embodiment, the cooling channels 44 are configured to establish a serpentine path for circulating the coolant C within the internal coolant circuit 42. The size, shape, and total number of cooling channels 44 are not intended to limit this disclosure and could be specifically tuned to the cooling requirements of the traction battery pack 18.

In use, the coolant C may be communicated into an inlet of the internal coolant circuit 42 and may then be communicated through the cooling channels 44 before exiting through an outlet of the internal coolant circuit 42. The coolant C may pick up heat conducted through the cross-member assembly 40 from one or more adjacent cell stacks 22 as it meanders along the serpentine path of the internal coolant circuit 42, thereby carrying away excessive heat and stabilizing the temperatures of the battery cells 32. Although not shown, the coolant C exiting from the internal coolant circuit 42 may be delivered to a radiator or some other heat exchanging device, be cooled, and then returned to the inlet of the internal coolant circuit 42 as part of a closed loop thermal management system.

A thermal interface material 46 may be provided between the cross-member assembly 40 and the battery cells 32 of each adjacent cell stack 22. The thermal interface material 46 may be configured to fixedly secure the battery cells 32 in place relative to the cross-member assembly 40. In an embodiment, lateral side-facing surfaces of the battery cells 32 are in direct contact with the thermal interface material 46. However, other configurations are contemplated within the scope of this disclosure.

The thermal interface material 46 may be further configured to maintain thermal contact between the battery cells 32 and the cross-member assembly 40, thereby facilitating thermal conductivity between these neighboring components during heat transfer events. Heat conducted from the battery cells 32 to the cross-member assembly 40 may then be carried away from the battery cells 32 by the coolant C that is circulated within the internal coolant circuit 42 of the cross-member assembly 40.

The cross-member assembly 40 may include an upper plateau 48 and a lower base 50. When positioned within the enclosure assembly 24 of the traction battery pack 18 in the manner shown in FIG. 3, the upper plateau 48 may interface with an upper enclosure structure 52, and the lower base 50 may interface with a lower enclosure structure 54. In some implementations, the upper plateau 48 may be bonded to the upper enclosure structure 52 and the lower base 50 may be bonded to the lower enclosure structure 54 for increasing the stiffness of the traction battery pack 18.

In an embodiment, the upper enclosure structure 52 is part of the enclosure cover 26 of the enclosure assembly 24, and the lower enclosure structure 54 is part of the enclosure tray 28 of the enclosure assembly 24. However, in other implementations, one or both of the upper and lower enclosure structures 52, 54 may be an intermediate structure positioned vertically between the cross-member assembly 40 and the enclosure cover 26 and/or vertically between the cross-member assembly 40 and the enclosure tray 28. Vertical and horizontal, for purposes of this disclosure, are with reference to ground and a general orientation of traction battery pack 18 when installed within the electrified vehicle 10 of FIG. 1.

In an embodiment, the cell stacks 22 and the cross-member assemblies 40 of the traction battery pack 18 extend longitudinally in a cross-vehicle direction. However, other configurations are further contemplated within the scope of this disclosure.

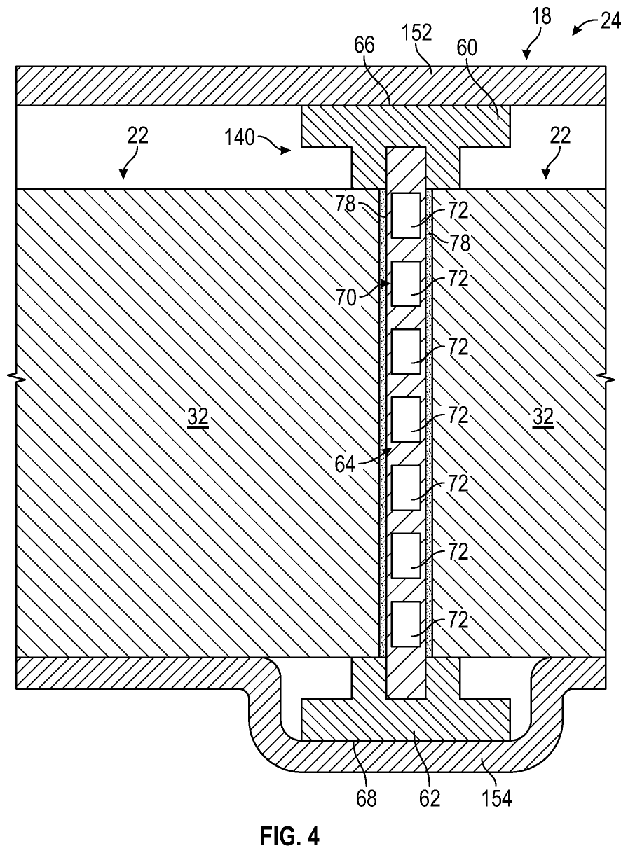

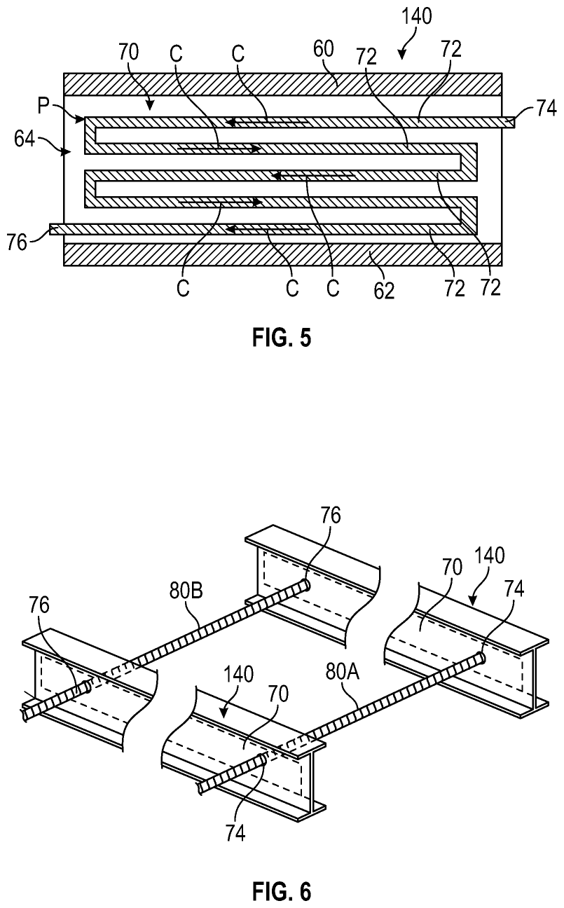

FIGS. 4 and 5 illustrate another exemplary cross-member assembly 140 that can be utilized within the traction battery pack 18. Additional cross-member assemblies of the traction battery pack 18 could include a similar design to the cross-member assembly 140 shown in FIGS. 4 and 5.

The cross-member assembly 140 may include a first or upper structural beam member 60, a second or lower structural beam member 62, and a heat exchanger portion 64 extending vertically between the upper structural beam member 60 and the lower structural beam member 62. The upper and lower structural beam members 60, 62 may be secured (e.g., bonded) to opposing vertical ends of the heat exchanger portion 64 to provide a desired cross-section of the cross-member assembly 140.

The upper structural beam member 60 may include an upper plateau 66, and the lower structural beam member 62 may include a lower base 68. When positioned within the enclosure assembly 24 of the traction battery pack 18 in the manner shown in FIG. 4, the upper plateau 66 may interface with an upper enclosure structure 152, and the lower base 68 may interface with a lower enclosure structure 154. The upper plateau 66 may be bonded to the upper enclosure structure 152 and the lower base 68 may be bonded to the lower enclosure structure 154 for increasing the stiffness of the traction battery pack 18. In an embodiment, the upper enclosure structure 152 is part of the enclosure cover 26 of the enclosure assembly 24, and the lower enclosure structure 154 is part of the enclosure tray 28 of the enclosure assembly 24. However, other implementations are contemplated within the scope of this disclosure.

In an embodiment, the upper structural beam member 60 and the lower structural beam member 62 of the cross-member assembly 140 are pultrusions, which implicates structure to these beam-like sections. A person of ordinary skill in the art having the benefit of this disclosure would understand how to structurally distinguish a pultruded beam structure from another type of structure, such as an extruded beam, for example.

The upper and lower structural beam members 60, 62 may be manufactured as part of a pultrusion process that utilizes a glass or carbon fiber (unidirectional or multidirectional mat) and a thermoset resin. A plurality of glass or carbon fiber strands may be pulled through the thermoset resin as part of the pultrusion process for manufacturing the upper and lower structural beam members 60, 62.

In an embodiment, the upper and lower structural beam members 60, 62 each include a T-shaped cross-section. However, other cross-sectional shapes are contemplated within the scope of this disclosure.

The heat exchanger portion 64 of the cross-member assembly 140 may include a mixed material design. For example, the heat exchanger portion 64 could be configured as a laminate of a metal (e.g., aluminum) and a plastic. However, other configurations of the heat exchanger portion 64 are contemplated within the scope of this disclosure.

The heat exchanger portion 64 of the cross-member assembly 140 may be configured to thermally manage the battery cells 32 of one or more cell stacks 22 of the traction battery pack 18. In an embodiment, the cross-member assembly 140 is arranged to thermally manage two cell stacks 22.

In an embodiment, an internal coolant circuit 70 may be provided within the cross-member assembly 140 for performing heat transfer functions. A coolant C may be selectively circulated through the internal coolant circuit 70 to thermally condition the battery cells 32 of the adjacent cell stacks 22.

The internal coolant circuit 70 may include a plurality of cooling channels 72 that extend inside the heat exchanger portion 64 of the cross-member assembly 140. The cooling channels 72 may be fluidly connected to one another, and in some implementations, may be arranged to establish a serpentine path P (see FIG. 5) for circulating the coolant C within the internal coolant circuit 70. The size, shape, and total number of cooling channels 72 are not intended to limit this disclosure and could be specifically tuned to the cooling requirements of the traction battery pack 18.

In use, the coolant C may be communicated into an inlet 74 of the internal coolant circuit 70 and may then be communicated through the cooling channels 72 before exiting through an outlet 76 of the internal coolant circuit 70. The coolant C may pick up heat conducted through the heat exchanger portion 64 from the cell stacks 22 as it meanders along the serpentine path P of the internal coolant circuit 70, thereby carrying away excessive heat and stabilizing the temperatures of the battery cells 32.

A thermal interface material 78 may be provided between the heat exchanger portion 64 of the cross-member assembly 140 and the battery cells 32 of each adjacent cell stack 22. The thermal interface material 78 may be configured to fixedly secure the battery cells 32 in place relative to the cross-member assembly 140. In an embodiment, lateral side-facing surfaces of the battery cells 32 are in direct contact with the thermal interface material 78. However, other configurations are contemplated within the scope of this disclosure.

The thermal interface material 78 may be further configured to maintain thermal contact between the battery cells 32 and the heat exchanger portion 64 of the cross-member assembly 140, thereby facilitating thermal conductivity between these neighboring components during heat transfer events. Heat conducted from the battery cells 32 to the cross-member assembly 140 may then be carried away from the battery cells 32 by the coolant C that is circulated within the internal coolant circuit 70 of the heat exchanger portion 64.

Referring now to FIG. 6, the internal coolant circuits 70 of adjacent cross-member assemblies 140 of the traction battery pack 18 may be fluidly connected to one another by one of more coolant hoses. In one exemplary implementation, the inlets 74 of the internal coolant circuits 70 of adjacent cross-member assemblies 140 are fluidly connected by a first coolant hose 80A, and the outlets 76 of the internal coolant circuits 70 of adjacent cross-member assemblies 140 are fluidly connected by a second coolant hose 80B. Other configurations are contemplated within the scope of this disclosure.

The multifunctional cross-member assemblies of this disclosure are capable of supporting various subcomponents of a battery cell stack. The multi-functional cross-member assemblies are further capable of acting as cold plates for thermally managing the battery cell stacks.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
a first cross-member assembly; and
a first cell stack supported by the first cross-member assembly,
wherein the first cross-member assembly includes an internal coolant circuit configured to thermally manage a plurality of battery cells of the first cell stack.

2. The traction battery pack as recited in claim 1, wherein the first cross-member assembly separates the first cell stack from a second cell stack of the traction battery pack.

3. The traction battery pack as recited in claim 1, wherein the internal coolant circuit includes a plurality of cooling channels arranged to establish a serpentine path.

4. The traction battery pack as recited in claim 1, wherein the first cross-member assembly includes an upper structural beam member, a lower structural beam member, and a heat exchanger portion extending between the upper structural beam member and the lower structural beam member.

5. The traction battery pack as recited in claim 4, wherein each of the upper structural beam member and the lower structural beam member includes a T-shaped cross-section.

6. The traction battery pack as recited in claim 4, wherein the upper structural beam member establishes a first pultrusion of the first cross-member assembly, and the lower structural beam member establishes a second pultrusion of the first cross-member assembly.

7. The traction battery pack as recited in claim 6, wherein the upper structural beam member includes an upper plateau that interfaces with an upper enclosure structure, and the lower structural beam member includes a lower base that interfaces with a lower enclosure structure.

8. The traction battery pack as recited in claim 4, wherein the heat exchanger portion is configured as a mixed material laminate.

9. The traction battery pack as recited in claim 4, wherein the heat exchanger portion includes the internal coolant circuit.

10. The traction battery pack as recited in claim 1, comprising a thermal interface material disposed between the first cell stack and the first cross-member assembly.

11. A traction battery pack, comprising:
a first cell stack;
a second cell stack; and
a first cross-member assembly arranged between the first cell stack and the second cell stack,
wherein the first cross-member assembly includes an internal coolant circuit configured to thermally manage a plurality of battery cells of the first cell stack and the second cell stack.

12. The traction battery pack as recited in claim 11, comprising a second cross-member assembly positioned on an opposite side of the second cell stack from the first cross-member assembly.

13. The traction battery pack as recited in claim 12, comprising a coolant hose fluidly connecting the internal coolant circuit of the first cross-member assembly to a second internal coolant circuit of the second cross-member assembly.

14. The traction battery pack as recited in claim 11, wherein the internal coolant circuit includes a plurality of cooling channels arranged to establish a serpentine path.

15. The traction battery pack as recited in claim 11, wherein the first cross-member assembly includes an upper structural beam member, a lower structural beam member, and a heat exchanger portion extending between the upper structural beam member and the lower structural beam member.

16. The traction battery pack as recited in claim 15, wherein each of the upper structural beam member and the lower structural beam member includes a T-shaped cross-section.

17. The traction battery pack as recited in claim 15, wherein the upper structural beam member establishes a first pultrusion of the first cross-member assembly, and the lower structural beam member establishes a second pultrusion of the first cross-member assembly.

18. The traction battery pack as recited in claim 17, wherein the upper structural beam member includes an upper plateau that interfaces with an upper enclosure structure, and the lower structural beam member includes a lower base that interfaces with a lower enclosure structure.

19. The traction battery pack as recited in claim 15, wherein the heat exchanger portion is configured as a mixed material laminate.

20. The traction battery pack as recited in claim 15, wherein the heat exchanger portion includes the internal coolant circuit.
